(19) United States
(12) Patent Application Publication
(10) Pub. No.: US 2025/0337971 A1
(43) Pub. Date: Oct. 30, 2025

(54) OUT-OF-HOME MEDIA MEASUREMENT

(71) Applicant: VIDEOAMP, INC., Los Angeles, CA (US)

(72) Inventors: Michael Ethan Hankin, San Francisco, CA (US); Qi Liu, Mead, CO (US); Adria Danielle Jewell, Marina del Rey, CA (US); James Robert Koehler, Boulder, CO (US); Candice Jasmine Gonzalez Slay, Fairfax, VA (US); Joshua Elliot Chasin, Point Lookout, NY (US); Cameron Stone Meierhoefer, Washington, DC (US)

(73) Assignee: VIDEOAMP, INC., Los Angeles, CA (US)

(21) Appl. No.: 19/195,582

(22) Filed: Apr. 30, 2025

Related U.S. Application Data
(60) Provisional application No. 63/640,876, filed on Apr. 30, 2024.

(51) Int. Cl. H04N 21/24; H04N 21/258

(52) U.S. Cl. CPC H04N 21/2407; H04N 21/2408; H04N 21/25841

(57) ABSTRACT

A system includes non-transitory computer-readable storage media configured to store instructions and processors communicatively coupled to the non-transitory computer-readable storage media. The processors may execute instructions, which may cause the system to perform operations. The operations may include obtaining first data associated with a person location, where the first data may be a subset of a collection of person location data. The operations may also include obtaining second data associated with one or more displays in a venue, where the second data may be a subset of a collection of display data. The operations may further include determining a first weight corresponding to the first data relative to the collection of person location data and a second weight corresponding to the second data relative to the collection of display data. The operations may also include obtaining an estimate of the viewership data using the first data and the second data.

### CROSS REFERENCE TO RELATED APPLICATIONS

This U.S. patent application claims priority to U.S. Provisional Patent Application No. 63/640,876, titled “OUT-OF-HOME MEDIA MEASUREMENT,” and filed on Apr. 30, 2024, the disclosure of which is hereby incorporated by reference in its entirety.

### TECHNICAL FIELD

This disclosure relates to out-of-home (OOH) advertising, and more specifically, to obtaining an audience measurement in an OOH environment.

### BACKGROUND

Unless otherwise indicated herein, the materials described herein are not prior art to the claims in the present application and are not admitted to be prior art by inclusion in this section.

Obtaining measurement data associated with displaying content on TVs may be limited to locations and/or settings in which the measurement data may be acquired. For example, traditional methods may rely on consumer surveys and/or data reported from in-home viewership. In most traditional methods, viewership data may be limited to in-home viewership, even though a significant portion of at least some viewership may occur outside of the home.

The subject matter claimed in the present disclosure is not limited to implementations that solve any disadvantages or that operate only in environments such as those described above. Rather, this background is only provided to illustrate one example technology area where some implementations described in the present disclosure may be practiced.

### SUMMARY

In an example embodiment, a system may include one or more non-transitory computer-readable storage media configured to store instructions. The system may also include one or more processors communicatively coupled to the one or more non-transitory computer-readable storage media and configured to, in response to execution of the instructions, cause the system to perform operations. The operations may include obtaining first data associated with a person location. The first data may be a subset of a collection of person location data. The operations may also include obtaining second data associated with one or more displays in a venue. The second data may be a subset of a collection of display data. The operations may further include determining a first weight corresponding to the first data relative to the collection of person location data and determining a second weight corresponding to the second data relative to the collection of display data. The operations may also include obtaining an estimate of the viewership data using the first data and the second data based on the determination of the first weight and the second weight.

In another embodiment, a method may include obtaining a request for viewership data from a requesting entity. The method may also include obtaining first data associated with a person location. The first data may be a subset of a collection of person location data. The method may further include obtaining second data associated with one or more displays in a venue. The second data may be a subset of a collection of display data. The method may also include determining a first weight corresponding to the first data relative to the collection of person location data and a second weight corresponding to the second data relative to the collection of display data. The method may further include obtaining an estimate of the viewership data using the first data and the second data based on the determination of the first weight and the second weight. The method may also include transmitting the estimate of the viewership data to the requesting entity.

The objects and advantages of the embodiments will be realized and achieved at least by the elements, features, and combinations particularly pointed out in the claims.

Both the foregoing general description and the following detailed description are given as examples and are explanatory and not restrictive of the invention, as claimed.

### DESCRIPTION OF DRAWINGS

Example implementations will be described and explained with additional specificity and detail using the accompanying drawings in which:

FIG. 1 illustrates a block diagram of an example system for obtaining an audience measurement in an out-of-home environment;

FIG. 2 illustrates a flowchart of an example method of obtaining an audience measurement in an out-of-home environment; and

FIG. 3 illustrates an example computing device.

### DETAILED DESCRIPTION

Determining a number of viewers for particular events shown on TVs may be beneficial to determine advertising of products, product marketing success, reach of advertisements and/or programming, and/or other related practices. In some instances, it may be desirable to obtain out-of-home (OOH) viewing data, such as viewing data of live sports events, advertisements, and/or other digital media in venues that may be OOH venues. In some instances, OOH consumption may occur in various venues, such as bars, restaurants, and/or other consumer gathering places, that may be public, private, or a combination thereof. A common difficulty in obtaining OOH viewing measurements is determining the number of viewers actually seeing an event in an OOH environment and the events that are displayed in the OOH environment.

Aspects of the present disclosure address these and other limitations by obtaining person location data and/or display data associated with a particular venue. One or more weights may be determined for the person location data and/or the display data relative to a collection of person location data and/or display data, respectively, where a first weight may correspond to the person location data and a second weight may correspond to the display data. An estimate of the viewership data may be obtained using the first weight and the second weight where the estimate of the viewership data may be an estimate of OOH viewing of an event.

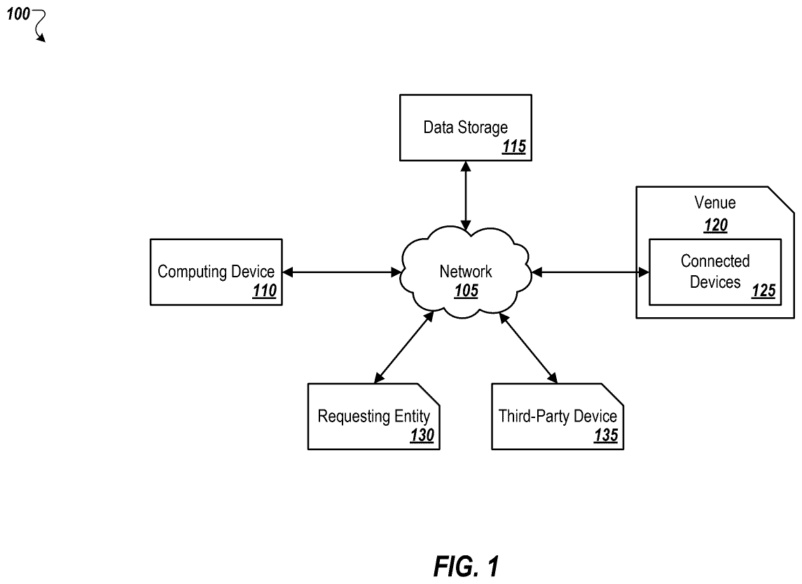

FIG. 1 illustrates a block diagram of an example system 100 for obtaining an audience measurement in an out-of-home (OOH) environment, in accordance with at least one embodiment of the present disclosure. The system 100 may include a network 105, a computing device 110, a data storage 115, and connected devices 125.

The network 105 may be operable to facilitate communications between one or more systems and/or devices that may be communicatively coupled to the network 105. For example, as illustrated in FIG. 1, the computing device 110 may be operable to communicate with the data storage 115 and/or the connected devices 125 via the network 105. The network 105 may include wireless network links, wired network links, and/or a combination of wireless and wired network links. For example, the network 105 may include various wired technologies, such as Ethernet, fiber optics, coaxial, etc., and/or the network 105 may include various wireless technologies, such as Bluetooth, Wi-Fi, satellite, infrared, etc., and/or combinations thereof.

The computing device 110 may be operable to perform operations associated with obtaining an audience measurement in an OOH environment, as described herein. The computing device 110 may be operable to communicate with one or more other systems and/or devices, such as via the network 105. For example, the computing device 110 may utilize the network 105 to communicate and/or transfer data with the data storage 115, the connected devices 125, a requesting entity 130, and/or a third-party device 135.

The data storage 115 may be operable to store data that may be used in association with obtaining an audience measurement in an OOH environment, as described herein. For example, the data storage 115 may store person location data, display data, venue data, event data, and/or any other data that may be used to determine an audience measurement in an OOH environment using the system 100 and/or the methods described herein. In some instances, the data storage 115 may be communicatively coupled with the computing device 110, such as via the network 105. Alternatively, or additionally, one or more other systems and/or devices may be operable to transmit and/or receive data from the data storage 115. For example, as illustrated, the connected devices 125, the requesting entity 130, and/or the third-party device 135 may be communicatively coupled to the data storage 115 via the network 105 and may be operable to transmit and/or receive data therefrom.

The connected devices 125 may be disposed within a venue 120 and may be viewable to persons within the venue 120. The connected devices 125 may be any display within the venue 120, such as one or more TVs, one or more projectors, and/or other display apparatuses. In some instances, initial data associated with the venue 120 and/or the connected devices 125 within and/or relative to the venue may be stored in the data storage 115. For example, a count of the number of IP connections associated with the venue 120, a count of the number of TVs that are included in the connected devices 125, a count of the number of TVs that are not included in the connected devices 125 (e.g., TVs that may not be able to track content displayed thereon), a count of the amount an event is displayed in the venue 120 in minutes, and/or other initial data related to the venue 120 and/or the connected devices 125 may be obtained and/or stored in the data storage 115.

The venue 120 may be any non-residential location where content may be displayed on a TV. For example, the venue 120 may be a bar, a restaurant, sports arena, and/or other public location that may be a gathering place for people to view content on a TV. In some instances, the venue 120 may be delineated by venue type (e.g., in instances in which there are more than one venue 120). For example, a venue type that may be associated with the venue 120 may include a bar, a sports bar, a restaurant, a sports restaurant, a stadium, a plaza, and/or other venue types.

In some instances, additional data associated with the venue 120 and/or the connected devices 125 may be obtained that may be supplementary to the initial data associated with the venue 120 and/or the connected devices 125. For example, the additional data may include dimensions associated with the venue 120 (which may include square footage of the venue 120 and/or a floor plan of the venue 120), locations of the connected devices 125 within the venue 120, a maximum number of patrons that may be within the venue 120, an average number of patrons within the venue 120, an average number of patrons within the venue 120 delineated by time of day, a recording of particular events broadcast on the connected devices 125 within the venue 120, and/or a count of the connected devices 125 displaying the same event.

In these and other embodiments, the data associated with the venue 120 and/or the connected devices 125 (e.g., the initial data and/or the additional data, as described) may be stored in the data storage 115 and may be obtained by the computing device 110 as part of obtaining an audience measurement in an OOH environment. For example, as the computing device 110 performs operations described herein, the computing device 110 may obtain the data associated with the venue 120 and/or the connected devices 125 from the data storage 115.

The connected devices 125 may include TVs that may be operable to determine content displayed thereon, such as an event, a broadcast, or other show. In some instances, the connected devices 125 may include automatic content recognition (ACR) that may be operable to determine what particular content may be displayed on the connected devices 125 as the particular content is displayed. In some instances, ACR for the connected devices 125 may be operable for linear content (e.g., over the air content). Alternatively, or additionally, some of the connected devices 125 may display digital content, which may be tracked by a provider of the digital content, such as an application on the connected devices 125 and/or the source of the digital content.

In these and other embodiments, the content displayed on the connected devices 125 (e.g., linear content via ACR and/or digital content) may be stored, such as in the data storage 115. The stored content may be obtained from the data storage 115 by the computing device 110 to be used in obtaining an audience measurement in an OOH environment.

In some instances, the computing device 110 may be operable to obtain person location data from the data storage 115. The person location data may be data associated with the presence of at least one person relative to the venue 120. For example, the person location data may include a physical location of a person relative to the venue 120 (e.g., in the venue 120) and/or the amount of time the person is located within the venue 120. Alternatively, or additionally, the person location data may be supplemented with additional person location data when the additional person location data may be available, which may improve the accuracy of the person location data. The additional person location data may include one or more of historical person location data associated with the person and/or with the venue 120 (e.g., person location data that may have been obtained at an earlier time), an interactive user response from the person (e.g., the person interacts with an application on a device (e.g., belonging to the person or to the venue 120) to indicate the persons presence within the venue 120), a personal identifier scan associated with the person within the venue 120 (e.g., the venue 120 obtains a scan of a driver's license associated with the person), wireless beacon data associated with the venue 120 (e.g., a Bluetooth beacon connection to a device associated with the person), a shared location associated with the person within the venue 120 (e.g., the person shares their location relative to the venue 120 to an application, a social network, and/or a similar setting), a maximum number of patrons allowed in the venue 120, and/or an average number of patrons in the venue 120, which may be delineated by the average number of patrons by the time of day in the venue 120.

In some instances, the person location data may be a subset of a collection of person location data, where the person location data may be associated with an individual person and the collection of person location data may be a representation of multiple people. Alternatively, or additionally, the person location data may be person location data associated with multiple persons and may be grouped based on one or more characteristics associated with the person location data. For example, the person location data may be grouped by venue type, by geographic location, by market, and the like.

The computing device 110 may be operable to determine a first weight that may correspond to the person location data. The first weight may be a representation of a number of patrons within the venue 120 that may view a particular event within the venue 120. The computing device 110 may utilize the person location data and/or the additional person location data to determine an estimate of the number of persons within the venue 120. Alternatively, or additionally, the first weight may facilitate an extrapolation of the person location data to the collection of person location data as the first weight may be associated with an estimated viewership within the venue 120 and the person location data associated with the venue 120 may be extrapolated to person location data associated with multiple venues using the first weight. In some instances, the extrapolation may be based on the venue type associated with the venue 120. For example, in instances in which the venue 120 is a sports bar, the extrapolation using the first weight associated with the venue 120 may be to multiple other venues that have a venue type of sports bar.

The computing device 110 may be operable to obtain display data from the data storage 115. The display data may be data associated with one or more displays (e.g., TVs) included in the venue 120 and/or characteristics associated with the TVs. For example, the display data may include a count of the number of IP connections available and/or used by the venue 120, a count of tracked TVs located in the venue 120, a count of untracked TVs located in the venue 120, and a count of the number of minutes an event is displayed on the TVs in the venue 120. Alternatively, or additionally, the display data may be supplemented with additional display data when the additional display data may be available, which may improve the accuracy of the display data. The additional display data may include a square footage metric associated with the venue 120, a floor plan of the venue 120, a venue-specific location of the TVs within the venue 120, and/or an accounting of the particular events broadcast on the TVs in the venue 120.

The display data may include ACR data associated with linear content (e.g., over the air events) and may obtain data publisher logs associated with digital content (e.g., streamed events). In some instances, the publisher logs may be segmented based on the location in which the digital content may be presented. For example, the publisher logs associated with in-home or private consumption may be separated from publisher logs associated with business or public consumption. The computing device 110 may obtain the ACR data and/or the publisher logs from the connected devices 125 and/or from the data storage 115 (which may include an aggregation of the ACR data and/or the publisher logs by a third-party data system, such as a viewership data aggregating system).

In some instances, the display data may be a subset of a collection of display data, where the display data may be associated with a particular venue (e.g., the venue 120) and the collection of display data may be a representation of multiple venues. Alternatively, or additionally, the display data may be display data associated with multiple venues and may be grouped based on one or more characteristics associated with the display data. For example, the display data may be grouped by venue type, by geographic location, by market, and the like.

The computing device 110 may be operable to determine a second weight that may correspond to the display data. The second weight may be a representation of a display of particular events within the venue 120. The computing device 110 may utilize the display data and/or the additional display data to determine an estimate of the number TVs within the venue 120 displaying the particular events and/or an amount of time the particular events are displayed on the TVs within the venue 120. Alternatively, or additionally, the second weight may facilitate an extrapolation of the display data to the collection of display data as the second weight may be associated with an estimated viewership within the venue 120 and the display data associated with the venue 120 may be extrapolated to display data associated with multiple venues using the second weight. In some instances, the extrapolation may be based on the venue type associated with the venue 120. For example, in instances in which the venue 120 is a casual restaurant, the extrapolation using the second weight associated with the venue 120 may be to multiple other venues that have a venue type of casual restaurant.

In these and other embodiments, the computing device 110 may use the first weight and the second weight to estimate a viewership of an event within the venue 120. For example, the computing device 110 may apply the first weight associated with the number of persons within the venue 120 to the collection of person location data to obtain first weighted data. The computing device 110 may also apply the second weight associated with the display of an event on TVs within the venue 120 to the collection of display data to obtain second weighted data. The computing device 110 may aggregate the first weighted data and the second weighted data to determine an estimate of the viewership of the event within the venue 120. In some instances, the aggregation to determine the viewership may be based on the event displayed within the venue 120. For example, in an instance, the first weight and the second weight associated with an NBA game displayed in the venue 120 may be used to obtain the first weighted data and the second weighted data, as described, and the first weighted data and the second weighted data may be aggregated to determine an estimate of the viewership of the NBA game.

In some instances, the computing device 110 may be operable to obtain additional data that may be combined with at least the first weight and/or the second weight and may be subsequently used to obtain the first weighted data and/or the second weighted data, as described. Alternatively, or additionally, the additional data may be used with the estimate of the viewership of the event within the venue 120 to confirm or adjust the estimate of the viewership. In some instances, the computing device 110 may incorporate the adjustment made to the estimate of the viewership to be applied to other estimates of viewership (e.g., for the same venue at a different time, a different venue at the same time, etc.). In some instances, the additional data may be panel data. In some instances, the panel data may be obtained by surveying patrons within the venue 120, such as during and/or after viewing the event in the venue 120.

Alternatively, or additionally, the computing device 110 may be operable to extrapolate the viewership associated with the venue 120 to other venues and/or with respect to a particular audience. For example, the viewership results associated with the venue 120 may be extrapolated to other venues that are of similar venue type and/or to other venues in a similar geographic market.

In some instances, the computing device 110 may be operable to perform an OOH measurement with respect to a particular audience. In some instances, the particular audience may be identified by one or more characteristics that may be associated with the particular audience. For example, a particular audience may be delineated by a household with which the particular audience may be associated and/or the particular audience may be identified using characteristics including, but not limited to, age, gender, income level, education level, political affiliation, and determined preferences associated with the audience and/or household, any of which may be further subdivided, such as by a range of the characteristics, an average of the characteristics, a maximum of the characteristics, a minimum of the characteristics, and so forth. For example, an OOH measurement may be obtained using the method described herein and may be considered in view of a particular audience having an income level that satisfies a threshold.

In some instances, the requesting entity 130 may submit a request to the computing device 110 via the network 105 for viewership data associated with a particular event, which may include a request for viewership data for venues having a particular type and for venues located in a particular geographic area. In response, the computing device 110 may obtain the personal location data and/or the display data from the data storage 115 and may perform the operations described herein to obtain an estimate for the viewership data. Upon obtaining the estimate for the viewership data, the computing device 110 may transmit the estimate for the viewership data to the requesting entity 130 via the network 105.

In some instances, the computing device 110 may transfer portions of the operations included in estimating the viewership within the venue 120 with the third-party device 135. For example, in some instances, the computing device 110 may request person location data associated with the venue 120 from the third-party device 135 and the third-party device 135 may return person location data associated with the venue 120 to the computing device 110, which may be used by the computing device 110 to determine at least the first weight, as described herein.

In some instances, the computing device 110 may transmit request data associated with an event to obtain person location data and/or display data. The request data may include, but not be limited to, broadcast day, broadcast time zone, broadcast start time, broadcast end time, normalized network, broadcast affiliate, series name, episode title, device ID, and so forth. In response, the third-party device 135 may generate the person location data and/or the display data, which may include device-level geolocation information that may include one or more timestamps associated therewith, device-level geo-spatial information pertaining to the location of the device, a venue type, a geographic region associated with the venue, demographic groupings associated with consumers within the venue (e.g., groupings by age, groupings by gender, etc.), aggregated and/or weighted number of minutes persons spent within the venue while the venue aired an event under measurement, aggregated and/or weighted number of persons present within the venue for a threshold amount of time while the venue aired the event under measurement, and/or other data.

In some instances, the computing device 110 may utilize the data (e.g., person location data and/or the display data) from the third-party device 135 to perform estimates associated with an advanced audience. For example, the computing device 110 may determine an amount of foot traffic within the venue 120 (e.g., an advanced audience) by utilizing the device-level geolocation data. In some instances, the computing device 110 may generate one or more identity graphs to be individually associated with consumers and/or the computing device 110 may associate mobile device identifiers with the consumer in the identity graph. The computing device 110 may use the identity graphs, mobile device identifiers, and/or other data to generate one or more advanced audiences, after which, estimations may be performed relative to the advanced audiences. In some instances, the advanced audiences may be generated by the computing device 110 in response to input received from a user. For example, a user may seek to understand foot traffic within the venue 120 and in response to an input from the user, the computing device 110 may obtain geolocation-based foot traffic data, such as from the identity graph, and may generate the advanced audience using the geolocation-based foot traffic data. In some instances, the computing device 110 may obtain the data for the advanced audience estimation from the third-party device 135, the data storage 115, and/or from other data sources.

The computing device 110 may obtain the output from the third-party device 135 directly, such as via an application programming interface (API), and/or may retrieve the output from the data storage 115 (in instances in which the third-party device 135 stores the output in the data storage 115). In some instances, the output from the third-party device 135 may be provided in real time, daily, weekly, and/or any other frequency, which may or may not be periodic.

Modifications, additions, or omissions may be made to the system 100 without departing from the scope of the present disclosure. For example, in some instances, some or all of the data storage 115 may be included in the computing device 110 such that the computing device 110 may access the data within the data storage 115 without the use of the network 105. In another example, the person location data and/or the display data may be obtained by the computing device 110 directly from the connected devices 125 and/or the venue 120, respectively, without the person location data and/or the display data being stored in the data storage 115.

In another example, the requesting entity 130 may be part of the computing device 110, such as an application running on the computing device 110. In such instances, the application (e.g., the requesting entity 130) may request viewership data associated with one or more venues and the computing device 110 may perform the operations described herein to obtain an estimate of the viewership data for the one or more venues and provide the estimate of the viewership data to the application. In another example, any of the components of FIG. 1 may be divided into additional or combined into fewer components.

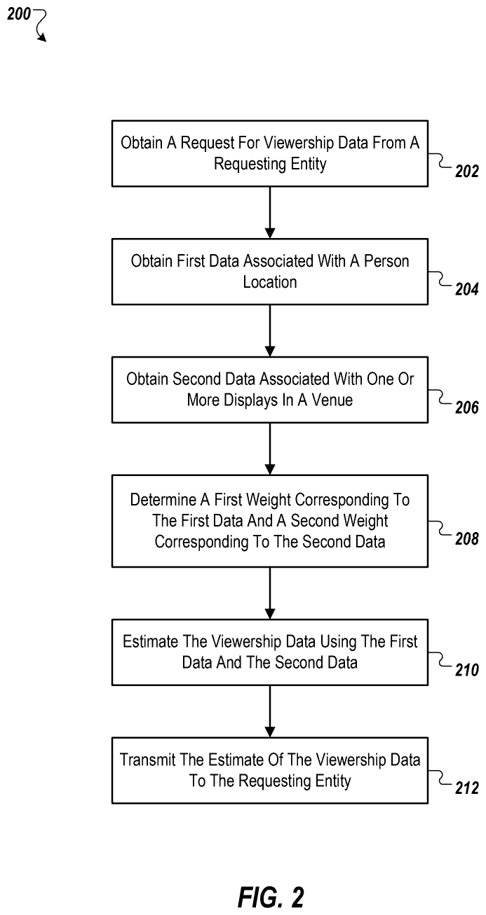

FIG. 2 illustrates a flowchart of an example method 200 of adaptation to multi-link operations in a multi-link device, in accordance with at least one embodiment of the present disclosure. The method 200 may be performed by processing logic that may include hardware (circuitry, dedicated logic, etc.), software (such as is run on a general purpose computer system or a dedicated machine), or a combination of both, which processing logic may be included in any computer system or device such as the computing device 110 of FIG. 1.

For simplicity of explanation, methods described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification may be capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

At block 202, a request for viewership data may be obtained from a requesting entity. The viewership data may be associated with viewing an event in a non-residential location.

At block 204, first data associated with a person location may be obtained. The first data may be a subset of a collection of person location data. The first data may include one or more of a person location relative to the venue and/or an amount of time a person is located at the venue.

In some instances, the first data may be supplemented with additional first data which may improve the accuracy of the first data. The additional first data may include one or more of historical first data, an interactive user response from a person, a personal identifier scan associated with the person, wireless beacon data associated with the venue, a shared location associated with the person, a maximum number of patrons in the venue, and an average number of patrons by time of day in the venue.

At block 206, second data associated with one or more displays in a venue may be obtained. The second data may be a subset of a collection of display data. The second data may include one or more of an IP connection count associated with the venue, a tracked TV count associated with the venue, an untracked TV count associated with the venue, and/or an event minute display count associated with a particular event displayed in the venue. A tracked TV may be operable to self-determine and track the particular event displayed thereon.

In some instances, the second data may be supplemented with additional second data which may improve the accuracy of the second data. The additional second data may include one or more of a square footage metric associated with the venue, a floor plan of the venue, a venue-specific location of the one or more displays within the venue, and particular events broadcast on the one or more displays.

At block 208, a first weight corresponding to the first data relative to the collection of person location data may be obtained. Alternatively, or additionally, a second weight corresponding to the second data relative to the collection of display data may be obtained.

The first weight may facilitate an extrapolation of the first data to the collection of person location data. Alternatively, or additionally, the first weight may be based on a venue type associated with the venue. The second weight may facilitate an extrapolation of the second data to the collection of display data. Alternatively, or additionally, the second weight may be based on the venue type.

At block 210, an estimate of the viewership data may be obtained using the first data and the second data. The estimate of the viewership data may be based on the determination of the first weight and the second weight. Obtaining the estimate of the viewership data may include applying the first weight to the collection of person location data to obtain first weighted data, applying the second weight to the collection of display data to obtain second weighted data, and aggregating the first weighted data and the second weighted data to obtain the estimate of the viewership data.

At block 212, the estimate of the viewership data may be transmitted to the requesting entity.

Modifications, additions, or omissions may be made to the method 200 without departing from the scope of the present disclosure. For example, the designations of different elements in the manner described is meant to help explain concepts described herein and is not limiting. Further, the method 200 may include any number of other elements or may be implemented within other systems or contexts than those described.

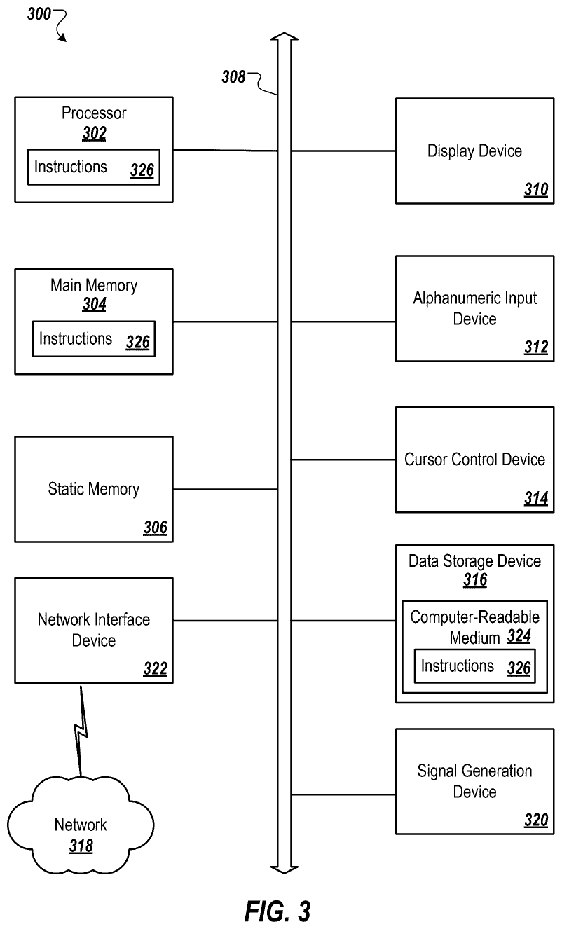

FIG. 3 illustrates an example computing device 300 within which a set of instructions, for causing the machine to perform any one or more of the methods discussed herein, may be executed. The computing device 300 may include a mobile phone, a smart phone, a netbook computer, a rackmount server, a router computer, a server computer, a personal computer, a mainframe computer, a laptop computer, a tablet computer, a desktop computer, or any computing device with at least one processor, etc., within which a set of instructions, for causing the machine to perform any one or more of the methods discussed herein, may be executed. In alternative implementations, the machine may be connected (e.g., networked) to other machines in a LAN, an intranet, an extranet, or the Internet. The machine may operate in the capacity of a server machine in client-server network environment. The machine may include a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” may also include any collection of machines that individually or jointly execute a set (or multiple sets) of instructions to perform any one or more of the methods discussed herein.

The computing device 300 includes a processing device 302 (e.g., a processor), a main memory 304 (e.g., read-only memory (ROM), flash memory, dynamic random access memory (DRAM) such as synchronous DRAM (SDRAM)), a static memory 306 (e.g., flash memory, static random access memory (SRAM)) and a data storage device 316, which communicate with each other via a bus 308.

The processing device 302 represents one or more general-purpose processing devices such as a microprocessor, central processing unit, or the like. More particularly, the processing device 302 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 302 may also include one or more special-purpose processing devices such as an application specific integrated circuit (ASIC), a field programmable gate array (FPGA), a digital signal processor (DSP), network processor, or the like. The processing device 302 is configured to execute instructions 326 for performing the operations and steps discussed herein.

The computing device 300 may further include a network interface device 322 which may communicate with a network 318. The computing device 300 also may include a display device 310 (e.g., a liquid crystal display (LCD) or a cathode ray tube (CRT)), an alphanumeric input device 312 (e.g., a keyboard), a cursor control device 314 (e.g., a mouse) and a signal generation device 320 (e.g., a speaker). In at least one implementation, the display device 310, the alphanumeric input device 312, and the cursor control device 314 may be combined into a single component or device (e.g., an LCD touch screen).

The data storage device 316 may include a computer-readable storage medium 324 on which is stored one or more sets of instructions 326 embodying any one or more of the methods or functions described herein. The instructions 326 may also reside, completely or at least partially, within the main memory 304 and/or within the processing device 302 during execution thereof by the computing device 300, the main memory 304 and the processing device 302 also constituting computer-readable media. The instructions may further be transmitted or received over a network 318 via the network interface device 322.

While the computer-readable storage medium 324 is shown in an example implementation to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

Terms used in the present disclosure and especially in the appended claims (e.g., bodies of the appended claims) are generally intended as “open terms” (e.g., the term “including” should be interpreted as “including, but not limited to.”).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is expressly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase preceding two or more alternative terms, whether in the description, claims, or drawings, should be understood to contemplate the possibilities of including one of the terms, either of the terms, or both of the terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although implementations of the present disclosure have been described in detail, various changes, substitutions, and alterations could be made hereto without departing from the spirit and scope of the present disclosure.

What is claimed is:

1. A system, comprising:
one or more non-transitory computer-readable storage media configured to store instructions; and
one or more processors communicatively coupled to the one or more non-transitory computer-readable storage media and configured to, in response to execution of the instructions, cause the system to perform operations, the operations comprising:
obtain first data associated with a person location in a venue, the first data being a subset of a collection of person location data;
obtain second data associated with one or more displays in the venue, the second data being a subset of a collection of display data;
determine a first weight corresponding to the first data relative to the collection of person location data and a second weight corresponding to the second data relative to the collection of display data; and
based on the determination of the first weight and the second weight, obtain an estimate of viewership data using the first data and the second data.

2. The system of claim 1, wherein the system is further to perform operations comprising:
obtain a request for the viewership data from a requesting entity; and
transmit the estimate of the viewership data to the requesting entity.

3. The system of claim 1, wherein the viewership data is associated with viewing an event in a non-residential location.

4. The system of claim 1, wherein the first data comprises one or more of a person location relative to the venue and an amount of time a person is located at the venue.

5. The system of claim 1, wherein the second data comprises one or more of:
an IP connection count associated with the venue;
a tracked TV count associated with the venue;
an untracked TV count associated with the venue; and
an event minute display count associated with a particular event displayed in the venue.

6. The system of claim 1, wherein the first weight facilitates an extrapolation of the first data to the collection of person location data and wherein the first weight is based on a venue type.

7. The system of claim 1, wherein the second weight facilitates an extrapolation of the second data to the collection of display data and wherein the second weight is based on a venue type.

8. The system of claim 1, wherein obtaining the estimate of the viewership data comprises:
applying the first weight to the collection of person location data to obtain first weighted data;
applying the second weight to the collection of display data to obtain second weighted data; and
aggregating the first weighted data and the second weighted data to obtain the estimate of the viewership data.

9. A method, comprising:
obtaining a request for viewership data from a requesting entity;
obtaining first data associated with a person location in a venue, the first data being a subset of a collection of person location data;
obtaining second data associated with one or more displays in the venue, the second data being a subset of a collection of display data;
determining a first weight corresponding to the first data relative to the collection of person location data and a second weight corresponding to the second data relative to the collection of display data;
based on the determination of the first weight and the second weight, obtaining an estimate of the viewership data using the first data and the second data; and
transmitting the estimate of the viewership data to the requesting entity.

10. The method of claim 9, wherein the viewership data is associated with viewing an event in a non-residential location.

11. The method of claim 9, wherein the first data comprises one or more of a physical location relative to the venue and an amount of time a person is located at the venue.

12. The method of claim 9, wherein the first data is supplemented with additional first data to improve an accuracy of the first data.

13. The method of claim 12, wherein the additional first data comprises one or more of historical first data, an interactive user response from a person, a personal identifier scan associated with the person, wireless beacon data associated with the venue, a shared location associated with the person, a maximum number of patrons in the venue, and an average number of patrons by time of day in the venue.

14. The method of claim 9, wherein the second data comprises one or more of:
an IP connection count associated with the venue;
a tracked TV count associated with the venue;
an untracked TV count associated with the venue; and
an event minute display count associated with a particular event displayed in the venue.

15. The method of claim 14, wherein a tracked TV is configured to self-determine and track the particular event displayed thereon.

16. The method of claim 9, wherein the second data is supplemented with additional second data to improve an accuracy of the second data.

17. The method of claim 16, wherein the additional second data comprises one or more of a square footage metric associated with the venue, a floor plan of the venue, a venue-specific location of the one or more displays within the venue, and particular events broadcast on the one or more displays.

18. The method of claim 9, wherein the first weight facilitates an extrapolation of the first data to the collection of person location data and wherein the first weight is based on a venue type.

19. The method of claim 9, wherein the second weight facilitates an extrapolation of the second data to the collection of display data and wherein the second weight is based on a venue type.

20. The method of claim 9, wherein obtaining the estimate of the viewership data comprises:
applying the first weight to the collection of person location data to obtain first weighted data;
applying the second weight to the collection of display data to obtain second weighted data; and
aggregating the first weighted data and the second weighted data to obtain the estimate of the viewership data.
